(19) United States
(12) Patent Application Publication
(10) Pub. No.: US 2008/0175177 A1
(43) Pub. Date: Jul. 24, 2008

(54) Method of enhancing continuous packet connectivity in a wireless communications system and related apparatus

(75) Inventor: Yu-Chih Jen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 12/010,283

(22) Filed: Jan. 23, 2008

Related U.S. Application Data
(60) Provisional application No. 60/886,292, filed on Jan. 23, 2007.

(51) Int. Cl. H04B 7/00

(52) U.S. Cl. 370/310

(57) ABSTRACT

A method for enhancing a CPC function in a wireless communications system includes transmitting a packet to a UE by a network after the UE activates a less operation and a discontinuous packet function of the CPC function, and retransmitting the packet according to a buffer length by the network when the UE does not successfully receive the packet.

### CROSS REFERENCE TO RELATED APPLICATIONS

This application claims the benefit of U.S. Provisional Application No. 60/886,292, filed on Jan. 23, 2007 and entitled “Method and Apparatus to realize Continuous Packet Connectivity and improve discontinuous transmission and reception”, the contents of which are incorporated herein by reference.

### BACKGROUND OF THE INVENTION

1. Field of the Invention

The present invention relates to a method of enhancing continuous packet connectivity in a wireless communications system and related apparatus, and more particularly, to a method and related communications apparatus for improving HS-SCCH less operation and thus enhance CPC.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate. For HSDPA and HSUPA, the 3rd Generation Partnership Project (3GPP) provides a Continuous Packet Connectivity (CPC) protocol specification, which includes features that, for user equipments (UEs) in CELL_DCH state, aim to significantly increase the number of packet data users for a cell, reduce the uplink noise rise and improve the achievable download capacity for VoIP.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

For an HSUPA UE, physical channels includes two uplink channels: an enhanced dedicated transport channel dedicated physical data channel (E-DPDCH), for transferring payload data, and an E-DCH dedicated physical control channel (E-DPCCH) for transmission of control signals, such as retransmission numbers. Furthermore, a bundle of downlink physical channels are employed in the HSUPA system and used for transmitting control signals associated with grants, ACKs and etc. The downlink physical channels include E-DCH relative grant channel (E-RGCH), E-DCH absolute grant channel (E-AGCH), E-DCH HARQ acknowledgement indicator channel (E-HICH) and fractional dedicated physical channel (F-DPCH). As for the MAC layer of the HSUPA UE, a MAC-e/es entity utilizes a transport channel of enhanced dedicated transport channel (E-DCH) for transmitting MAC packet data to the physical layer with supporting a transmission time interval (TTI) of 10 milliseconds (ms) or 2 ms.

For CELL_DCH state, CPC operation defines an active state and an inactive state. For any data channels (ex. E-DCH), the active state represents that there are data packets transmitted on the data channels. For any control channels (ex. HS-DPCCH), the active state represents that there are data packets transmitted on the data channels corresponding to the control channels, such as HS-PDSCH corresponding to HS-DPCCH. On the contrary, for any data channels, the inactive state represents that there are no data packets transmitted on the data channels. For any control channels, the inactive state represents that there are no data packets transmitted on the data channels corresponding to the control channels.

According to the CPC protocol specification, discontinuous uplink transmission (uplink DTX) is a mechanism where control signals are transmitted on the uplink control channels according to defined discontinuous patterns during the inactive state of corresponding uplink data channels in order to maintain signal synchronization and power control loop with less control signaling. The uplink control channels include a normal DPCCH in addition to the abovementioned uplink control channels of HSUPA and HSDPA.

Moreover, discontinuous uplink reception (uplink DRX) of CPC is utilized to control the UE to transmit E-DCH in specific time interval and has to be configured with uplink DTX. If there has been no E-DCH transmission for a configurable number of transmission time intervals (ex. the interval of UE_Inactivity_Threshold), a radio network controller (RNC) can configure the UE to restrict the start of E-DCH transmission to a MAC_DTX_cycle pattern. UE_DTX_DRX_Offset is also used in uplink DRX, allowing the UEs to have different E-DCH start time.

Furthermore, discontinuous downlink reception (downlink DRX) of CPC is configured by the RNC and allows the UE to restrict the downlink reception times in order to reduce power consumption. When the downlink DRX is enabled, the UE is not required to receive physical downlink channels except for several specific situations.

In addition, CPC includes an HS-SCCH less operation, which is a special mode of HSDPA operation for reducing HS-SCCH overhead for a hybrid automatic repeat request (HARQ) process, thereby reducing UE power consumption. Under this mode, the first HS-DSCH transmission of the HARQ process corresponding to small transport blocks (TBs) on pre-defined HS-DSCH is performed without accompaniment of HS-SCCH signaling, and the HARQ retransmissions corresponding to the first HS-DSCH transmission are accompanied with the HS-SCCH signaling if the retransmissions are needed. Accordingly, the UE needs blind decoding for TB data of the first transmission based on predefined TB size and channel coding set. If blind decoding is success, the UE reports ACK to the base station, also known Node-B, through HS-SCCH; otherwise, the UE reports nothing and waits for retransmission initiated by the Node-B. In order to combine the first transmission with the subsequent retransmissions, the HS-SCCH transmits required control signals of physical channel coding set, TB size, UE identity, a pointer and etc., where the pointer notify the UE of the TTI where the previous transmission has been performed. In addition, The UE can report ACK or NACK for the retransmission, and the retransmission is restricted to two times. The first and second retransmissions can be asynchronous with respect to the first transmission, and with respect to each other. The accompanying HS-SCCH follows the same timing relationship with the HS-PDSCH transmission as legacy transmissions do.

According to the related protocol specifications or references, when DRX of a UE-is configured and not has been deactivated, the corresponding Node B scheduler should take into account the DRX configuration on HS-SCCH less operation. However, this information is not fully utilized by the UE when it's trying to receive HS-SCCH and HS-PDSCH transmission when DRX cycle(s), HS-SCCH less (re)transmission, and 13 TTI buffer length together appear certain expectation. In addition, due to choice to DRX cycle, there might not be able to have retransmissions.

### SUMMARY OF THE INVENTION

According to the present invention, a method for enhancing a CPC function in a wireless communications system comprises transmitting a packet to a UE by a network after the UE activates a less operation and a discontinuous packet function of the CPC function, and retransmitting the packet according to a buffer length by the network when the UE does not successfully receive the packet.

According to the present invention, a method for enhancing a CPC function in a wireless communications system comprises triggering a less operation of the CPC function by a UE, and transmitting a message to the UE by a network to indicate that there are going to be only transmissions of the less operation for a specified period.

According to the present invention, a communications device for enhancing a CPC function in a wireless communications system comprises a control circuit for realizing functions of the communications device, a central processing unit installed in the control circuit for executing a program code to operate the control circuit, and a memory coupled to the central processing unit for storing the program code. The program code comprises transmitting a packet to a UE after the UE activates a less operation and a discontinuous packet function of the CPC function, and retransmitting the packet according to a buffer length when the UE does not successfully receive the packet.

According to the present invention, a communications device for enhancing a CPC function in a wireless communications system comprises a control circuit for realizing functions of the communications device, a central processing unit installed in the control circuit for executing a program code to operate the control circuit, and a memory coupled to the central processing unit for storing the program code. The program code comprises triggering a less operation of the CPC function by a UE, and transmitting a message to the UE to indicate that there are going to be only transmissions of the less operation for a specified period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 and FIG. 4 are flowchart diagrams of processes according to embodiments of the present invention.

### DETAILED DESCRIPTION

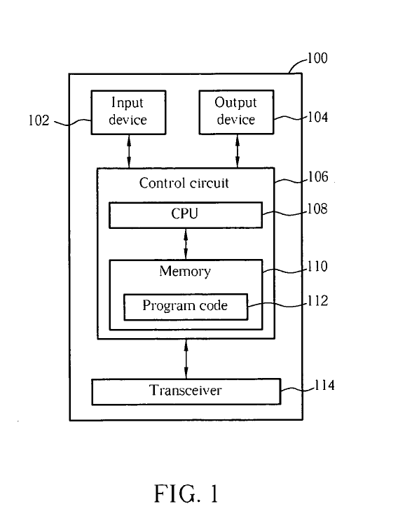

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a High Speed Package Access (HSPA) system of the third generation (3G) mobile communications system, LTE system, or other related communications system, and can be user or network equipment.

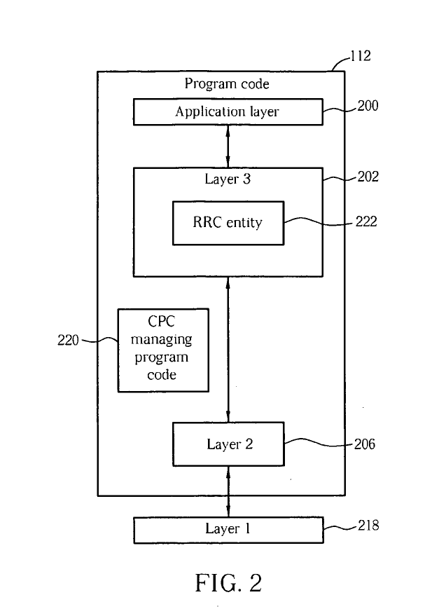

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206. In addition, when the communications device 100 implements a user equipment, the RRC entity 222 can change an RRC state according to system requirements or radio conditions, to switch between an RRC_IDLE state and an RRC_CONNECTED state. The RRC_CONNECTED state can be CELL_PCH, URA_PCH, CELL_FACH or CELL_DCH state in 3G system.

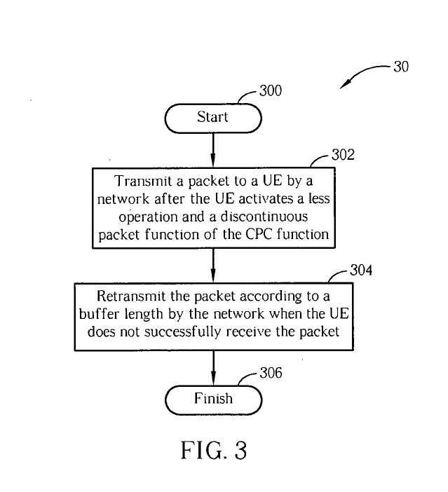

As mentioned above, for UEs in CELL_DCH state, the network can configure CPC to significantly increase the number of packet data users for a cell, reduce the uplink noise rise and improve the achievable download capacity for VoIP. CPC includes mechanisms of uplink DTX, uplink DRX, downlink DRX, and HS-SCCH less operation, for reducing UE power consumption. In such a situation, the embodiment of the present invention provides a CPC managing program code 220 to avoid system malfunction. Please refer to FIG. 3, which illustrates a schematic diagram of a process 30 according to an embodiment of the present invention. The process 30 is utilized for enhancing CPC in a wireless communications system, and can be compiled into the CPC managing program code 220. The process 30 comprises the following steps:
Step 300: Start.
Step 302: Transmit a packet to a UE by a network after the UE activates a less operation and a discontinuous packet function of the CPC function.
Step 304: Retransmit the packet according to a buffer length by the network when the UE does not successfully receive the packet.
Step 306: Finish.

According to the process 30, after the UE activate the less operation (e.g. HS-SCCH less operation) and the discontinuous packet function (e.g. DTX/DRX), if a packet is not successfully received by the UE and needed to be retransmitted, the network can retransmit the packet according to the buffer length via the embodiment of the present invention. In such a situation, the HARQ operation of HS-DSCH can be either synchronous or asynchronous.

For example, if the network cannot schedule the retransmission within the buffer length apart from the previous transmission, the embodiment of the present invention can preferably retransmit the packet via a normal transmission with control information, e.g. HS-SCCH, or the first transmission of HS-SCCH less operation without control information.

Oppositely, if the network can schedule the retransmission within the buffer length apart from the previous transmission, the embodiment of the present invention preferably retransmits the packet via the less operation after a specified duration which is within the buffer length apart from the corresponding previous transmission, e.g. a specified number of cycles of the discontinuous packet function or a transmission opportunity after a round trip time corresponding to the packet. In such a situation, the UE can further detect whether the retransmission is successful or whether application requirement is maintained according to the buffer length and the specified duration. For example, the UE can detect whether a current subframe is the specified duration after the previous transmission, as well as there is no data being received or control information being detected in the current subframe, and the difference between the reception time of the previous transmission and the reception time at a next cycle after the current subframe is longer than the buffer length, to detect whether the retransmission is successful by the UE. In addition, when the retransmission is not successful or the application requirement is not maintained, the UE can preferably send a negative acknowledgment signal to the network.

Therefore, via the embodiment of the present invention, the HARQ operation of HS-DSCH can be either synchronous or asynchronous, and the network can retransmit packets according the buffer length, such as 13 TTI (transmit time interval) in HS-SCCH less operation.

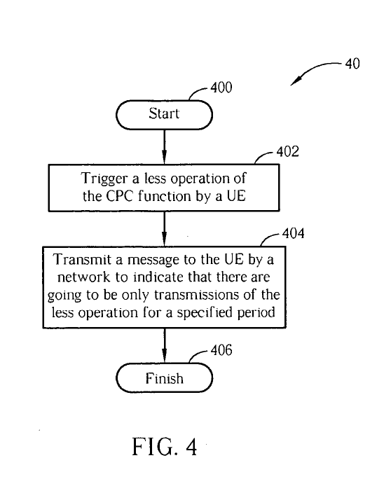

Please refer to FIG. 4, which illustrates a schematic diagram of a process 40. The process 40 is utilized for enhancing CPC in a wireless communications system, and can be compiled into the CPC managing program code 220. The process 40 comprises the following steps:
Step 400: Start.
Step 402: Trigger a less operation of the CPC function by a UE.
Step 404: Transmit a message to the UE by a network to indicate that there are going to be only transmissions of the less operation for a specified period.
Step 406: Finish.

According to the process 40, after the UE triggers the less operation, the network can send a message to the UE to indicate that there are going to be only transmissions of the less operation for a specified period. In such a situation, the UE can determine that there are going to be only transmissions of the less operation for the specified period.

Preferably, other than the less operation (e.g. HS-SCCH less operation), the UE can further trigger a discontinuous packet function (e.g. DTX/DRX) of the CPC function. In addition, the specified period is preferably corresponding to a number of cycles of the discontinuous packet function until another message from the network, or a transmission opportunity after a round trip time corresponding to a packet, or a duration of a service.

Therefore, via the process 40, the UE can determine that there are going to be only transmissions of the less operation for the specified period according to the message sent by the network, so as to enhance transmission efficiency and reduce power consumption.

In summary, the embodiment of the present invention can improve HS-SCCH less operation and thus enhance CPC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing a Continuous Packet Connectivity, called CPC hereinafter, function in a wireless communications system comprising:
transmitting a packet to a user equipment, called UE hereinafter, by a network after the UE activates a less operation and a discontinuous packet function of the CPC function; and
retransmitting the packet according to a buffer length by the network when the UE does not successfully receive the packet.

2. The method of claim 1, wherein retransmitting the packet according to the buffer length by the network when the UE does not successfully receive the packet is retransmitting the packet by the network via a normal transmission or the less operation when the packet cannot be scheduled to be sent within the buffer length apart from the previous transmission.

3. The method of claim 2, wherein retransmitting the packet by the network via the normal transmission comprises transmitting control information.

4. The method of claim 2, wherein retransmitting the packet by the network via the less operation is retransmitting the packet by the network via a first transmission of the less operation without control information.

5. The method of claim 1, wherein retransmitting the packet according to the buffer length by the network when the UE does not successfully receive the packet is retransmitting the packet by the network via the less operation if a retransmission of the less operation can be scheduled to be sent after a specified duration which is within the buffer length apart from the corresponding previous transmission.

6. The method of claim 5, wherein the specified duration is a specified number of cycles of the discontinuous packet function or a transmission opportunity after a round trip time corresponding to the packet.

7. The method of claim 5 further comprising detecting whether the retransmission is successful by the UE according to the buffer length and the specified duration.

8. The method of claim 7, wherein detecting whether the retransmission is successful by the UE according to the buffer length and the specified duration is detecting whether a current subframe is the specified duration after the previous transmission, as well as there is no data being received or control information being detected in the current subframe, and the difference between the reception time of the previous transmission and the reception time at a next cycle after the current subframe is longer than the buffer length, to detect whether the retransmission is successful by the UE.

9. The method of claim 7 further comprising sending a negative acknowledgment signal to the network when the retransmission is not successful.

10. The method of claim 5 further comprising detecting whether application requirement is maintained by the UE based on the buffer length and the specified duration.

11. The method of claim 10, wherein detecting whether application requirement is maintained by the UE based on the buffer length and the specified duration is detecting whether a current subframe is the specified duration after the previous transmission, as well as there is no data being received or control information being detected in the current subframe, and the difference between the reception time of the previous transmission and the reception time at a next cycle after the current subframe is longer than the buffer length, to detect whether the application requirement is maintained.

12. The method of claim 10 further comprising sending a negative acknowledgment signal to the network when the application requirement is not maintained.

13. The method of claim 10 further comprising triggering a process or a specified operation by the UE according to requirement of the UE.

14. A method for enhancing a Continuous Packet Connectivity, called CPC hereinafter, function in a wireless communications system comprising:
triggering a less operation of the CPC function by a user equipment, called UE hereinafter; and
transmitting a message to the UE by a network to indicate that there are going to be only transmissions of the less operation for a specified period.

15. The method of claim 14, wherein the UE further triggers a discontinuous packet function of the CPC function, the specified period is corresponding to a number of cycles of the discontinuous packet function until another message from the network or a transmission opportunity after a round trip time corresponding to a packet.

16. The method of claim 14, wherein the specified period is a duration of a service.

17. The method of claim 14, wherein the less operation can be control channel less operation or operation with reduced or eliminated transmission of control information or operation with pruned-size control information transmission or operation with transmission of shared control information or operation without mandatory accompanying transmission of control information associated with corresponding data transmission.

18. A communications device for enhancing a Continuous Packet Connectivity, called CPC hereinafter, function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
transmitting a packet to a user equipment, called UE hereinafter, after the UE activates a less operation and a discontinuous packet function of the CPC function; and
retransmitting the packet according to a buffer length when the UE does not successfully receive the packet.

19. The communications device of claim 18, wherein retransmitting the packet according to the buffer length when the UE does not successfully receive the packet is retransmitting the packet via a normal transmission or the less operation when the packet cannot be scheduled to be sent within the buffer length apart from the previous transmission.

20. The communications device of claim 19, wherein retransmitting the packet via the normal transmission comprises transmitting control information.

21. The communications device of claim 19, wherein retransmitting the packet via the less operation is retransmitting the packet via a first transmission of the less operation without control information.

22. The communications device of claim 18, wherein retransmitting the packet according to the buffer length when the UE does not successfully receive the packet is retransmitting the packet via the less operation if a retransmission of the less operation can be scheduled to be sent after a specified duration which is within the buffer length apart from the corresponding previous transmission.

23. The communications device of claim 22, wherein the specified duration is a specified number of cycles of the discontinuous packet function or a transmission opportunity after a round trip time corresponding to the packet.

24. The communications device of claim 22, wherein the UE detects whether the retransmission is successful according to the buffer length and the specified duration.

25. The communications device of claim 24, wherein the UE detects whether the retransmission is successful according to the buffer length and the specified duration is performed by detecting whether a current subframe is the specified duration after the previous transmission, as well as there is no data being received or control information being detected in the current subframe, and the difference between the reception time of the previous transmission and the reception time at a next cycle after the current subframe is longer than the buffer length, to detect whether the retransmission is successful by the UE.

26. The communications device of claim 24, wherein the UE sends a negative acknowledgment signal to the communications device when the retransmission is not successful.

27. The communications device of claim 22, wherein the UE detects whether application requirement is maintained based on the buffer length and the specified duration.

28. The communications device of claim 27, wherein the UE detects whether application requirement is maintained based on the buffer length and the specified duration is performed by detecting whether a current subframe is the specified duration after the previous transmission, as well as there is no data being received or control information being detected in the current subframe, and the difference between the reception time of the previous transmission and the reception time at a next cycle after the current subframe is longer than the buffer length, to detect whether the retransmission is successful by the UE.

29. The communications device of claim 27, wherein the UE sends a negative acknowledgment signal to the network when the application requirement is not maintained.

30. The communications device of claim 27, wherein the UE triggers a process or a specified operation according to requirement of the UE.

31. A communications device for enhancing a Continuous Packet Connectivity, called CPC hereinafter, function in a wireless communications system comprising:
a control circuit for realizing functions of the communications device;
a central processing unit installed in the control circuit for executing a program code to operate the control circuit; and a memory coupled to the central processing unit for storing the program code;
wherein the program code comprises:
triggering a less operation of the CPC function by a user equipment, called UE hereinafter; and
transmitting a message to the UE to indicate that there are going to be only transmissions of the less operation for a specified period.

32. The communications device of claim 31, wherein the UE further triggers a discontinuous packet function of the CPC function, the specified period is corresponding to a number of cycles of the discontinuous packet function until another message from the network or a transmission opportunity after a round trip time corresponding to a packet.

33. The communications device of claim 31, wherein the specified period is a duration of a service.

34. The communications device of claim 31, wherein the less operation can be control channel less operation or operation with reduced or eliminated transmission of control information or operation with pruned-size control information transmission or operation with transmission of shared control information or operation without mandatory accompanying transmission of control information associated with corresponding data transmission.
